(19) United States
(12) Patent Application Publication
(10) Pub. No.: US 2024/0382983 A1
(43) Pub. Date: Nov. 21, 2024

(54) FULLY ADJUSTABLE ROTARY NOZZLE ASSEMBLY

(71) Applicant: K-Rain Manufacturing Corp., Riviera Beach, FL (US)

(72) Inventor: Matthew Dwight BROOKS, Boynton Beach, FL (US)

(21) Appl. No.: 18/666,338

(22) Filed: May 16, 2024

Related U.S. Application Data
(60) Provisional application No. 63/467,432, filed on May 18, 2023.

(51) Int. Cl. B05B 3/02

(52) U.S. Cl. CPC B05B 3/021

(57) ABSTRACT

An adjustable rotary nozzle assembly in accordance with an embodiment of the present disclosure includes an upper valve element mounted in a drive element such that the upper valve element rotates with the drive element, wherein the drive element and upper valve element are mounted in a base and a lower valve element is mounted in a bottom of the base in a desired orientation relative to the base and the upper valve element such that the upper valve element and lower valve element cooperate to provide an adjustable arcuate slot opening though which water passes.

### CROSS-REFERENCE TO RELATED APPLICATIONS

The present application claims benefit of and priority to U.S. Provisional Patent Application Ser. No. 63/467,432 filed May 18, 2023, entitled FULLY ADJUSTABLE ROTARY NOZZLE ASSEMBLY, the entire content of which is hereby incorporated by reference herein.

### BACKGROUND

### Field

The present application relates to an adjustable rotary nozzle that includes an upper valve element made of a compliant material and having a novel construction and assembly.

### Description of the Art

Rotary nozzle sprinklers typically include rotary nozzle assemblies including molded plastic elements that are glued together. Such conventional nozzle assemblies, however, suffer from problems related to the difficulty of consistently molding components to meet necessary tolerance which result in leaks and the need for additional sealing elements. For example, in conventional rotary nozzle sprinklers, when the upper and lower valve parts have the same durometer, an exact diameter to diameter fit must be provided to allow for proper function. In such conventional sprinklers, variation in circularity or dimensions may result in a gap that allows water to pass through. Further, in conventional rotary nozzle sprinklers, the lower valve element and base are typically molded together as one part, however, this integral part is difficult to properly mold since the critical geometry of the lower valve element is far away from the gate during molding which increases the chance of an imperfection in the critical portion of the valve element.

Accordingly, it would be beneficial to provide an adjustable rotary nozzle assembly that avoids these and other problems.

### SUMMARY

It is an object of the present disclosure to provide a rotary nozzle assembly that improves performance and reduces the chance of leaking.

A rotary nozzle assembly in accordance with an embodiment of the present disclosure includes: a drive element including at least one outer thread; an upper valve element mounted in the threaded drive element, the upper valve element made of a compliant material such that a seal is provided at a connection between the threaded drive element and the upper valve element; a base including a top portion with an inner thread and a bottom portion, wherein the drive element and upper valve element are movably mounted in the top portion of the base with the outer thread interacting with the inner thread to set a position of the drive element in the base; a lower valve element mounted in the bottom portion of the base; and an arc adjustment ring operably connected to the drive element and configured to rotate the drive element and upper valve element such that an opening between the upper valve element and the lower valve element is adjusted.

In embodiments, the drive element includes a shaped slot and the upper valve element includes a shaped finger configured to cooperate with the shaped slot to provide a sealed connection between the drive element and the upper valve element.

In embodiments, the upper drive element is snap fit into the drive element.

In embodiments, the upper valve element includes a lower spiral edge.

In embodiments, the lower valve element includes an upper spiral edge configured to cooperate with the lower spiral edge to define arcuate opening.

In embodiments, the base includes at least one receiving slot and at least one ramp provided adjacent the at least one receiving slot, wherein the receiving slot is configured to receive a connecting tab provided on the lower valve element and the connecting tab is configured to slide along the at least one ramp as the lower valve element is rotated to secure it in the base.

In embodiments, the at least one ramp is configured to secure the connecting tab and maintain the lower valve element in a desired position.

In embodiments, the at least one shaped slot has a first shape that corresponds to a second shape of the shape of the upper nozzle.

In embodiments, the drive element rotated with the arc adjustment ring to set a size of the opening between the lower valve surface and the top valve surface.

A method of constructing an adjustable nozzle assembly in accordance with an embodiment of the present disclosure includes: mounting an upper valve element in a drive element, wherein the upper valve element is made of a compliant material; mounting the drive element, including the upper valve element, in a top portion of a base; mounting a lower valve element in a bottom portion of the base, such that an arcuate slot is defined between the upper valve element and the lower valve element.

In embodiments, the drive element includes an outer thread configured to interact with an inner thread provided on the drive element such that the drive element and the upper valve element moves with the drive element.

In embodiments, the drive element includes at least one shaped slot and the upper valve element includes at least one shaped finger that is configured to connect the drive element and the upper valve element.

In embodiments, the upper valve element includes a lower spiral edge and the lower valve element includes an upper spiral edge, wherein the lower spiral edge and the lower spiral edge cooperate to define the arcuate opening between the upper valve element and the lower valve element.

In embodiments, the base includes at least one receiving slot and at least one ramp provided adjacent the at least one receiving slot, wherein the receiving slot is configured to receive a connecting tab provided on the lower valve element and the connecting tab is configured to slide along the at least one ramp as the lower valve element is rotated to secure it in the base.

In embodiments, the at least one ramp is configured to secure the connecting tab and maintain the lower valve element in a desired position.

In embodiments, the at least one shaped slot has a first shape that corresponds to a second shape of the shape of the upper nozzle.

In embodiments, the drive element rotated with the arc adjustment ring to set a size of the opening between the lower valve surface and the top valve surface.

### BRIEF DESCRIPTION OF THE DRAWINGS

FIG. 1 illustrates an adjustable rotary nozzle assembly mounted in a nozzle housing of a rotary nozzle sprinkler in accordance with an embodiment of the present invention;

FIG. 2 illustrates a detailed view of an upper portion of the adjustable nozzle assembly in accordance with an embodiment of the present invention;

FIG. 2A illustrates a top perspective view of an upper valve element of the upper portion of the adjustable nozzle assembly in accordance with an embodiment of the present disclosure;

FIG. 2B illustrates a bottom perspective view of the upper valve element of the upper portion of the adjustable nozzle assembly in accordance with an embodiment of the present disclosure;

FIG. 2C illustrates a top perspective view of the drive element of the adjustable nozzle assembly in accordance with an embodiment of the present invention;

FIG. 2D illustrates a bottom perspective view of the drive element of the adjustable nozzle assembly in accordance with an embodiment of the present invention;

FIG. 2E illustrates the direction of movement of the upper valve element into the drive element in accordance with an embodiment of the present invention;

FIG. 3 illustrates a base in which the upper portion of the rotary nozzle may be mounted in accordance with an embodiment of the present invention;

FIG. 4A illustrates the upper portion being fitted into the base in accordance with an embodiment of the present invention;

FIG. 4 illustrates the upper portion of the nozzle mounted in the base of FIG. 3 in accordance with an embodiment of the present invention;

FIG. 5 illustrates a detailed view of a lower valve member in accordance with an embodiment of the present invention;

FIG. 6 illustrates the lower valve element mounted in the bottom of the base of FIG. 3 such that the lower valve element interacts with the upper portion of the rotary nozzle in accordance with an embodiment of the present invention;

FIG. 6A illustrates the movement of the lower valve element into the base in accordance with an embodiment of the present invention;

FIG. 7 illustrates a top view of the lower valve element in the bottom of the base of FIG. 3 with the upper portion of the rotary nozzle removed in accordance with an embodiment of the present invention; and

FIG. 8 illustrates an exemplary flow chart showing a method of making an adjustable rotary nozzle assembly in accordance with an embodiment of the present disclosure.

### DESCRIPTION OF THE EMBODIMENTS

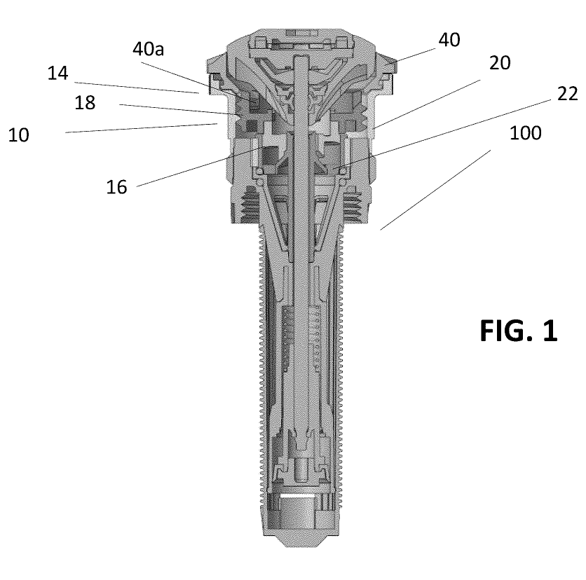

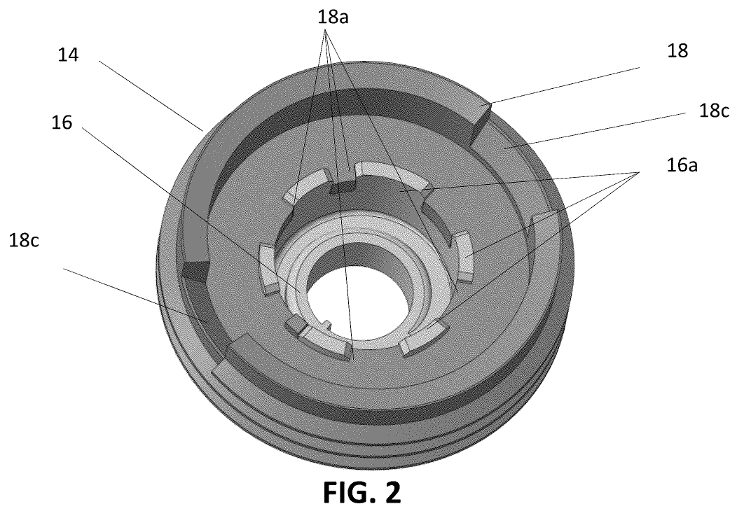

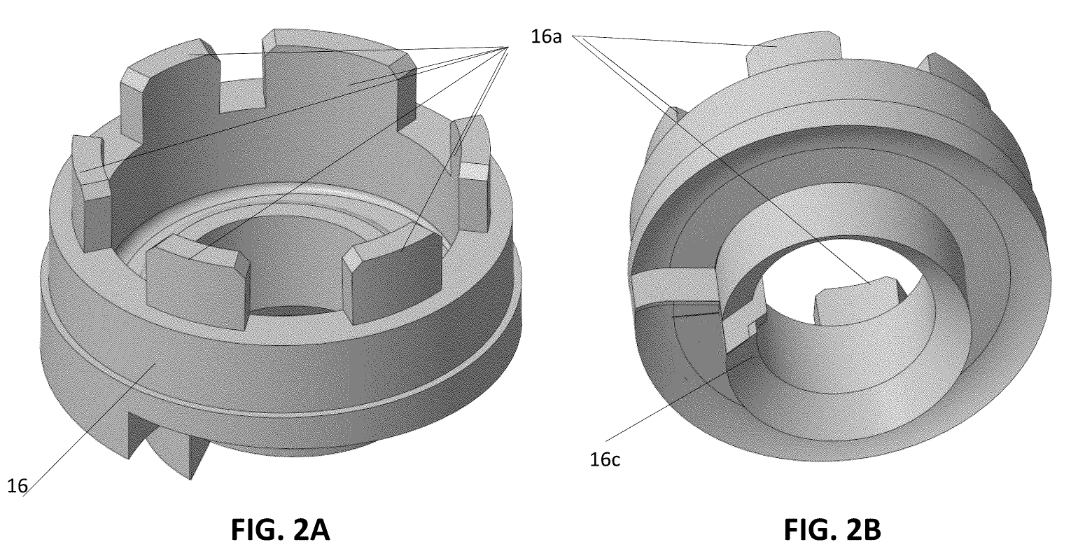

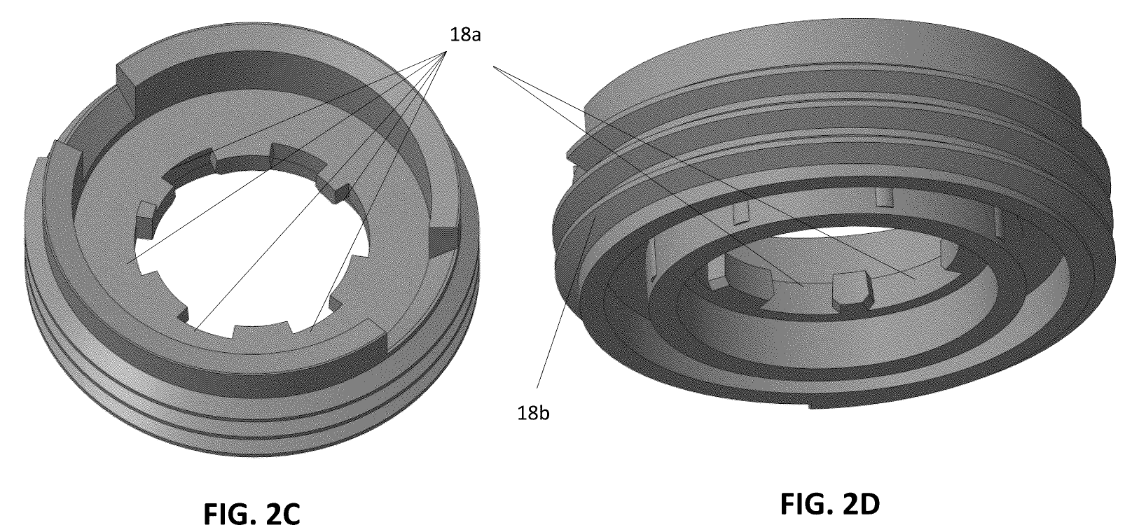

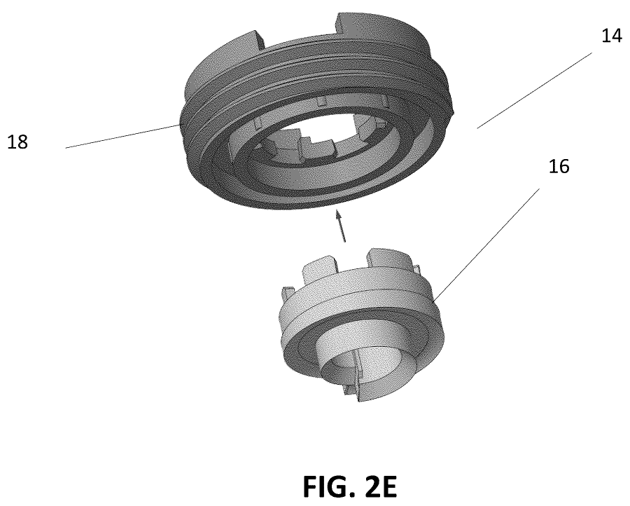

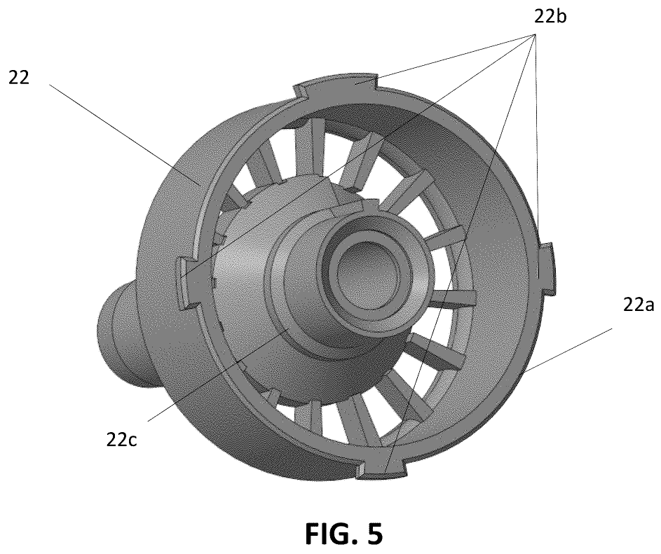

FIG. 1 illustrates an adjustable rotary nozzle assembly 10 mounted in a nozzle housing 100 in accordance with an embodiment of the present disclosure. In embodiments, the adjustable rotary nozzle assembly 10 includes an upper portion 14, including an upper valve element 16 and a threaded drive element 18 connected thereto. In embodiments, as illustrated in FIG. 2, for example, the upper valve element 16 may include one or more fingers 16a, each of which is configured to interact with a corresponding finger slot 18a of the threaded drive element 18. In embodiments, the fingers 16a and slots 18a are shaped and configured to engage each other to maintain a connection between the upper valve element 16 and the drive element 18. In embodiments, the fingers 16a and slots 18a may vary in shape in order to ensure a desired orientation of the upper valve element 16 in the drive element 18. In embodiments, the upper valve element 16 may include a lower valve surface 16c configured to interact with a lower valve element 22 (see FIGS. 5-7 for example) to provide an adjustable arcuate slot S through which water may flow. FIG. 2A illustrates a top perspective view of the upper valve element 16 and FIG. 2B illustrates a bottom perspective view thereof. FIG. 2C is a top perspective view of the drive element 18 and FIG. 2D is a bottom perspective view thereof.

In embodiments, the upper valve element 16 may be made of a compliant material, such as hard durometer rubber. In embodiments, the compliant material may be any elastomer with a hardness of about 65D on the Shore Hardness Scale. In embodiments, the compliant material of the upper valve element 16 may include any material suitable for use as a sprinkler seal with respect to durability, chemical resistance and dimensional stability, to name a few. In embodiments, any compliant material may be used. In embodiments, a compliant material is sufficiently flexible to conform to the mating portion of the lower valve element 22 to prevent creating small gaps that water can pass through. The flexibility of the compliant material allows for relaxation of tolerances required between the valve elements.

In embodiments, the fingers 16a may have a dove-tail shape and the slots 18a may have a complementary shape. In embodiments, other shapes may be used for the fingers 16a and the slots 18a. In embodiments, the shape or size of the fingers 16a may vary from finger to finger such that an orientation of the upper valve element 16 in the drive element 18 may be set (see FIG. 2, for example). In embodiments, the upper valve element 16 may be inserted into the drive element 18 in the direction indicated by the arrow of FIG. 2E. In embodiments, once the upper valve element 16 is mounted in the drive element 18, it rotates with the drive element. In embodiments, the drive element 18 includes an exterior thread 18b on the outer surface thereof.

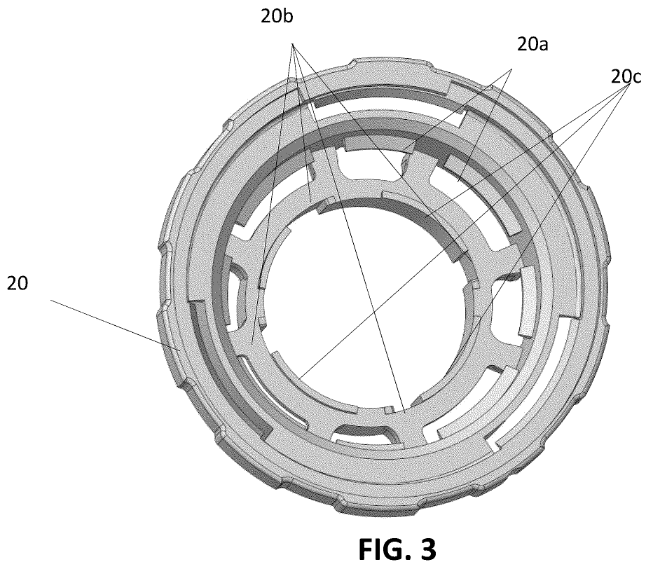

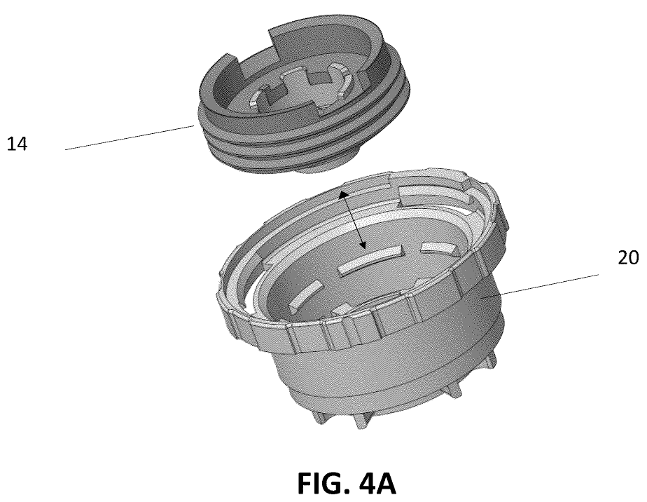

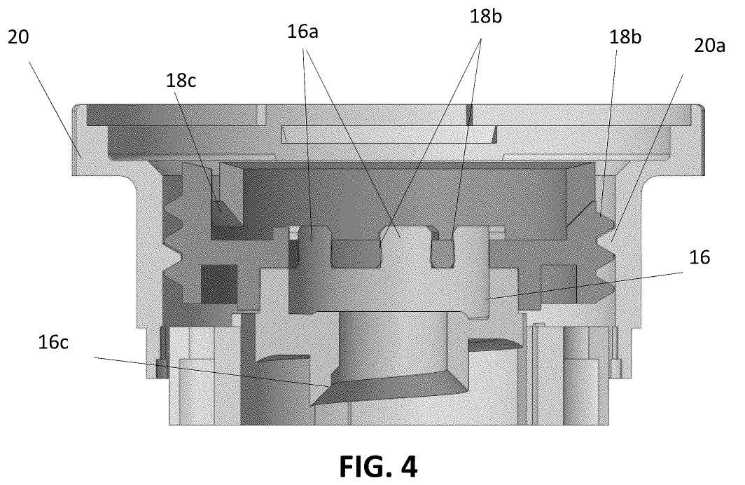

In embodiments, the exterior thread 18b may interact with an inner thread 20a provided on an inner wall of the base 20 (see FIG. 3, for example). In embodiments, the inner thread 20a may be provided in segments as generally illustrated in FIG. 3, for example. In embodiments, the inner thread 20a may be continuous. In embodiments, the drive element 18, including the upper valve element 16, is moved into the base 20 as indicated in FIG. 4A and secured in place via interaction of the threads 18b and 20a. In embodiments, a pitch of the threads 18b and 20a may be set to position the upper valve element 16 at a desired position in the base 20 as generally shown in FIG. 4.

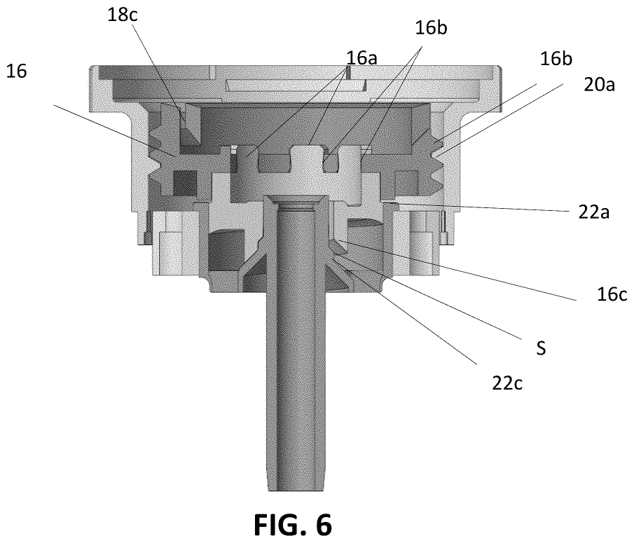

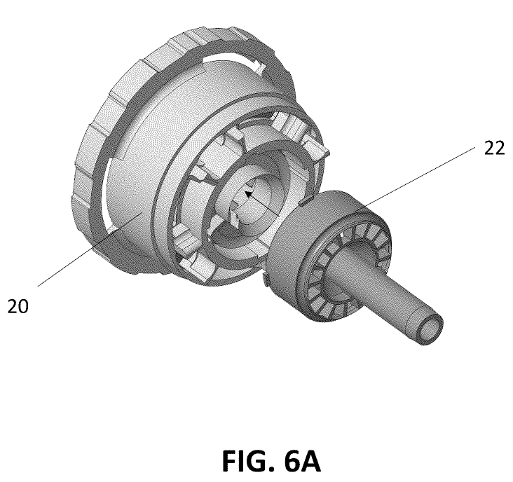

In embodiments, a lower valve element 22 (see FIG. 5) may be mounted in a bottom of the base 20 as indicated in FIG. 6A and may interact with the upper valve element 16 to provide the adjustable arcuate slot S (see FIG. 6) through which water may flow. In embodiments, the base 20 may include a plurality of mounting slots 20b (see FIG. 3, for example) provided in a bottom portion thereof. In addition, a plurality of mounting ramps 20c (FIG. 4) are provided on an upper surface of the bottom portion, adjacent to each of the mounting slots 20b. A mounting surface 22a of the lower valve element 22 includes a plurality of mounting protrusions 22b that are configured to interact with the mounting slots 20b and mounting ramps 20c of the base 20 to secure the lower valve element 22 in place in the base (see FIG. 6). In embodiments, the mounting protrusions 22b, slots 20b and ramps 20c may be configured and shaped such that the orientation of the lower valve element 22 in the base 20 may be set. In embodiments, an upper valve surface 22c is provided on the lower valve element 22 and interacts with the lower valve surface 16c of the upper valve element 16 to provide the adjustable arcuate slot S.

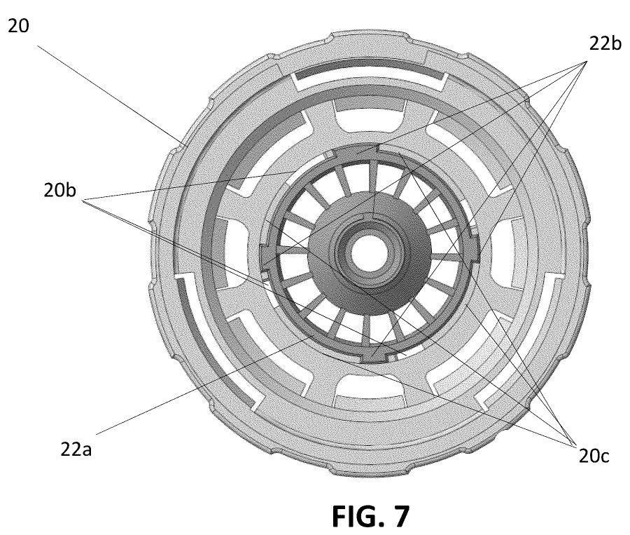

In embodiments, the lower valve element 22 may be mounted in the base 20 as shown in FIG. 7. In embodiments, the lower valve element 22 is inserted from the bottom of the base (see FIG. 6A) and the protrusions 22b pass through the mounting slots 20b. Thereafter, the lower valve element 22 may be rotated to a desired position as the protrusions 22b engage with the ramps 20c. In embodiments, the shape, size or configuration of the slots 20b and/or the ramps 20c may be used to provide a desired orientation of the lower valve element 22 in the base 20 while also holding it securely in place. This installation process also simplifies construction of the valve assembly 10.

In embodiments, an arc adjustment ring 40 (see FIG. 1) is operably connected to the drive element 18 to rotate the drive element. In embodiments, as noted above, the upper valve element 16 may be mounted in the drive element 18 such that the upper valve element rotates with the drive element 18. In embodiments, the drive element 18 may include drive slots 18c (see FIG. 2, for example) that receive drive tabs 40a (see FIG. 1, for example) of the arc adjustment ring 40. In embodiments, the arc adjustment ring 40 may be rotated to rotate the drive element 18, and the upper valve element 16 to adjust the size of the arcuate slot S, which determines an arc of coverage for the rotary nozzle sprinkler. In embodiments, water passes through the slot S, such that the size of the acuate slot determines the arc of coverage of the sprinkler using the assembly 10.

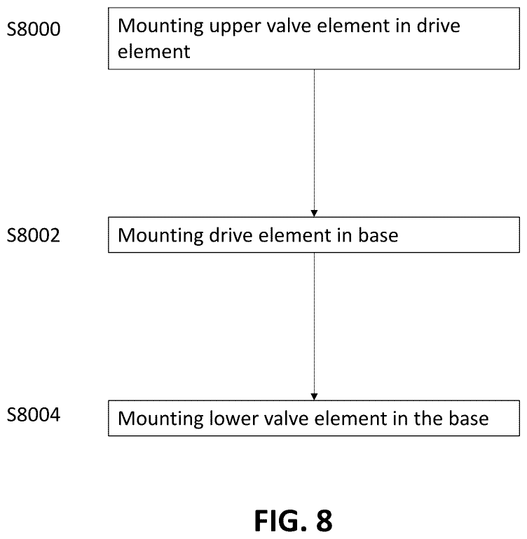

FIG. 8 illustrates a flow chart showing an exemplary process of constructing the nozzle assembly 10. In embodiments, at step S8000, the upper valve element 16 may be mounted in the drive element 18 as illustrated in FIG. 2E, for example. In embodiments, the upper valve element 16 may be made of a compliant material and the fingers 16a and slots 18b may be configured to ensure a desired orientation of the upper valve element in the drive element 18. In embodiments, the upper valve element 16 may be press fit into the driver element 18.

In embodiments, in step S8002, the drive element 18, including the upper valve element 16 may be mounted in the base 20 as illustrated in FIG. 4A, for example. In embodiments, the thread 18b interacts with the thread 20a to secure the drive element 18 in the base 20. In embodiments a pitch of the threads 18b and 20a may be set to provide a desired positioning of the drive element 18 and the upper valve element 16 in the base 20.

In embodiments, in step S8004, the lower valve element 22 may be mounted in the base 20 as indicated in FIG. 6A, for example, which includes the drive element 18 and the upper valve element 16. In embodiments, the protrusions 22b, slots 20b and/or ramps 20c are configured and shaped to provide a desired orientation of the lower valve element 22 in the base 20 and relative to the upper valve element 16. In embodiments, after step S8004, the assembly 10 may be mounted in a nozzle housing 100 in a conventional manner, including mounting the assembly 10 such that the arc adjustment ring 40 is operably connected to the driver element 18 to modify the size of the slot S defined between the lower valve surface 16c and the upper valve surface 22c.

In embodiments, the assembly 10 of the present disclosure provides a number of benefits. In embodiments, the use of a compliant material for the upper valve element 16 provides for a reliable water seal at all angles or arcs of coverage. As noted above, in conventional sprinklers small differences in individual parts (such as imperfect circularity, for example) may result in leaks which are eliminated based on the use of the compliant upper valve element 16. In embodiments, in conventional sprinklers, arcs of coverage beyond 180 degrees may result in leakage since the two ribs no longer have the main shut off on the opposite side of the valve to counteract them. In the assembly 10, the compliant material in the upper valve element 16 reduces the chance of a leak. In addition, since the elements of the assembly 10 are self-aligned and press fit or screwed into position, gluing steps can be eliminated which simplifies construction, improves quality and reduces costs. Further, the use of a separate lower valve element 22 which is not integrated into the base allows the critical geometry of the lower valve element 22 to be position closer to the gate during molding which reduced the chances of imperfections during molding. Extracting out the repeated geometry of the base 20 into its own shared part solves molding issues and makes molding of both the base 20 and the lower valve element 22 more maintainable and reliable. In addition, in conventional assemblies, an O-ring is required to provide a seal along the outside of the valving member which is eliminated in the assembly 10 by having the upper valve element 16 seal against the lower valve element 22 along the outer cylindrical surface.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. An adjustable rotary nozzle assembly comprises:
a drive element including at least one outer thread;
an upper valve element mounted in the drive element, the upper valve element made of a compliant material such that a seal is provided at a connection between the drive element and the upper valve element;
a base including a top portion with an inner thread and a bottom portion,
wherein the drive element and upper valve element are movably mounted in the top portion of the base with the outer thread interacting with the inner thread to set a position of the drive element and upper valve element in the base;
a lower valve element mounted in the bottom portion of the base; and
an arc adjustment ring operably connected to the drive element and configured to rotate the drive element and upper valve element in the base such that a size of an opening between the upper valve element and the lower valve element is adjusted.

2. The adjustable rotary nozzle assembly of claim 1, wherein the drive element includes a shaped slot and the upper valve element includes a shaped finger configured to cooperate with the shaped slot to provide a sealed connection between the drive element and the upper valve element.

3. The adjustable rotary nozzle assembly of claim 1, wherein the upper drive element is snap fit into the drive element.

4. The adjustable rotary nozzle assembly of claim 1, wherein the upper valve element includes a lower spiral edge.

5. The adjustable rotary nozzle assembly of claim 4, wherein the lower valve element includes an upper spiral edge configured to cooperate with the lower spiral edge to define the opening between the upper valve element and the lower valve element.

6. The adjustable rotary nozzle assembly of claim 4, wherein the base includes a receiving slot and at least one ramp provided adjacent the at least one receiving slot, wherein the receiving slot is configured to receive a connecting tab provided on the lower valve element and the connecting tab is configured to slide along the at least one ramp as the lower valve element is rotated to secure it in the base.

7. The adjustable rotary nozzle assembly of claim 6, wherein the at least one ramp is configured to secure the connecting tab and maintain the lower valve element in a desired position.

8. The adjustable rotary nozzle assembly of claim 1, wherein the shaped slot has a first shape that corresponds to a second shape of the shaped finger of the upper nozzle.

9. The adjustable nozzle assembly of claim 1, wherein the drive element rotates with the arc adjustment ring to set a size of the opening between the lower valve surface and the top valve surface.

10. A method of constructing an adjustable nozzle assembly comprises:
mounting an upper valve element in a drive element, wherein the upper valve element is made of a compliant material;
mounting the drive element, including the upper valve element, in a top portion of a base;
mounting a lower valve element in a bottom portion of the base, such that an arcuate slot is defined between the upper valve element and the lower valve element.

11. The method of claim 10, wherein the drive element includes an outer thread configured to interact with an inner thread provided on the drive element such that the drive element and the upper valve element moves with the drive element.

12. The method of claim 10, wherein the drive element includes a shaped slot and the upper valve element includes a shaped finger that is configured to connect the drive element and the upper valve element.

13. The method of claim 10, where in the upper valve element includes a lower spiral edge and the lower valve element includes an upper spiral edge, wherein the lower spiral edge and the lower spiral edge cooperate to define the arcuate opening between the upper valve element and the lower valve element.

14. The method of claim 10, the base includes at least one receiving slot and at least one ramp provided adjacent the at least one receiving slot, wherein the receiving slot is configured to receive a connecting tab provided on the lower valve element and the connecting tab is configured to slide along the at least one ramp as the lower valve element is rotated to secure it in the base.

15. The method of claim 14, wherein the at least one ramp is configured to secure the connecting tab and maintain the lower valve element in a desired position.

16. The method of claim 10, wherein the at least one shaped slot has a first shape that corresponds to a second shape of the shape of the upper nozzle.

17. The method of claim 10, wherein the drive element rotated with the arc adjustment ring to set a size of the opening between the lower valve surface and the top valve surface.
